(19) United States
(12) Patent Application Publication
(10) Pub. No.: US 2010/0120531 A1
(43) Pub. Date: May 13, 2010

(54) AUDIO CONTENT MANAGEMENT FOR VIDEO GAME SYSTEMS

(75) Inventors: Chris J. Esaki, Redmond, WA (US); Earnest M.S. Yuen, Redmond, WA (US); Keiichi Yano, Redmond, WA (US); Francois Klier, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/270,778

(22) Filed: Nov. 13, 2008

(51) Int. Cl. A63F 9/24; G06F 17/00; H04N 7/26

(52) U.S. Cl. 463/35; 700/94; 386/124

(57) ABSTRACT

Techniques and systems for managing audio content for use with a video game playable via a video game system. A graphical user interface (“GUI”) associated with the video game presents visual objects representing audio content in any format aggregated from a number of different sources. Aggregation is achieved by dynamically populating a data structure with data objects configured to store information about various audio sources and audio content stored thereby. The data objects are used to dynamically render the graphical user interface. Via the GUI, a user browses aggregated audio content and selects particular audio content for use with the video game. The data objects and the information stored or referenced thereby (e.g., metadata) may also be used for searching/sorting, translating/transferring, or playing available audio content.

### BACKGROUND

Video game systems execute a wide variety of video game applications to provide interactive user gaming experiences. The playing of audio content is an important part of the interactive user gaming experience provided by many popular video game applications, especially interactive music games. Many video games are designed for use with specific, pre-configured audio content that is used to provide the interactive gaming experience. Users, however, may desire to hear, and have legal access to, a more diverse selection of audio content that would enhance the experience provided by a video game such as a interactive music game.

### SUMMARY

Systems and techniques for managing audio content for use with a video game playable via a video game system are described herein. One or more audio content sources, other than an audio content catalog pre-configured for use with a particular video game, are dynamically detected by the video game system. Examples of such audio content sources include but are not limited to: portable media players or recorders; personal computers; network-based media download or streaming services or centers; and individual computer-readable storage media such as hard drives, memory sticks, USB storage devices and the like.

Audio content items, which may have disparate formats, are aggregated from detected audio content sources by populating a data structure with data objects. The data objects are configured to store references to individual content sources and to audio content items stored thereby, including metadata information associated with individual audio content items. As data is stored in the data objects, the data objects are used to dynamically render, via a graphical user interface (“GUI”) for the video game, certain visual objects representing audio content stored on detected audio content sources. For example, for each audio content item, visual objects rendered via the GUI may include the name of the audio content item and an icon representing its source. Via the GUI, a user can browse, search/sort, and select audio content items for use with the video game, regardless of the source or original format of the selected audio content items. In one exemplary implementation, when a user selects a particular audio content item for use with the video game, the selected audio content item is translated into a format usable by the video game, if necessary, and placed into the audio content catalog pre-configured for use with the video game.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified functional block diagram of a video game system configured to execute a video game with which aspects of an audio content management system are used.

FIG. 2 is a simplified functional block diagram of the audio content management system shown in FIG. 1.

FIG. 3 is a flowchart illustrating certain aspects of a method for managing audio content for use with the video game playable by the video game system shown in FIG. 1.

FIG. 4 is a simplified functional block diagram of an exemplary configuration of an operating environment in which the audio content management system shown in FIG. 2 and/or the method illustrated in FIG. 3 may be implemented or used.

### DETAILED DESCRIPTION

The systems and techniques for managing audio content for use with a video game playable via a video game system that are described herein provide for a dynamic, coherent visual representation of audio content items having disparate sources and formats using a single graphical user interface. Via the graphical user interface, a user browses, sorts/searches, and selects particular audio content for use with the video game.

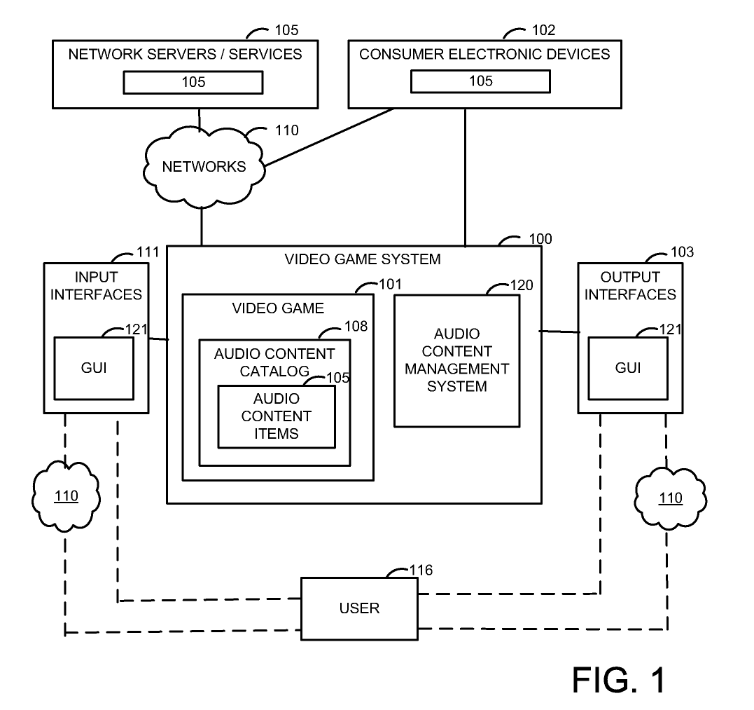

Turning to the drawings, where like numerals designate like components, FIG. 1 is a simplified block diagram of a network-based or console-based video game system 100 having input interfaces 111 and output interfaces 103. Input interfaces 111 represent physical or logical elements that define the way a user 115 inputs information to video game system 100. One type of input interface 111 is a graphical user interface (“GUI”) 121 (discussed further below), which uses tools such as windows or menus to organize information. Other examples of input interfaces are physical controls such as remote controls, game controllers, displays, mice, pens, styluses, trackballs, keyboards, microphones, or scanning devices. Output interfaces 103 represent physical or logical elements that define the way user 115 receives information from video game system 100. As shown, GUI 121 also serves as an output interface. Other examples of output interfaces are speakers, displays, and the like. It will be appreciated that many of the same physical devices or logical constructs may function as both input interfaces 111 and output interfaces 103.

As shown, video game system 100 is configured to execute a video game 101 using audio content items 105 obtained from a number of audio content sources (discussed further below). Audio content items 105 are commercial or non-commercial audio samples in any compressed or un-compressed file format, including but not limited to music samples, speech samples, and the like. Audio content sources in general may be any electronic devices, systems, or services (or any physical or logical element of such devices, systems, or services), operated by commercial or non-commercial entities, which legally store DRM-free audio content items 105. Exemplary audio content sources include audio content catalog 108, network servers/services 104, and consumer electronic devices 102.

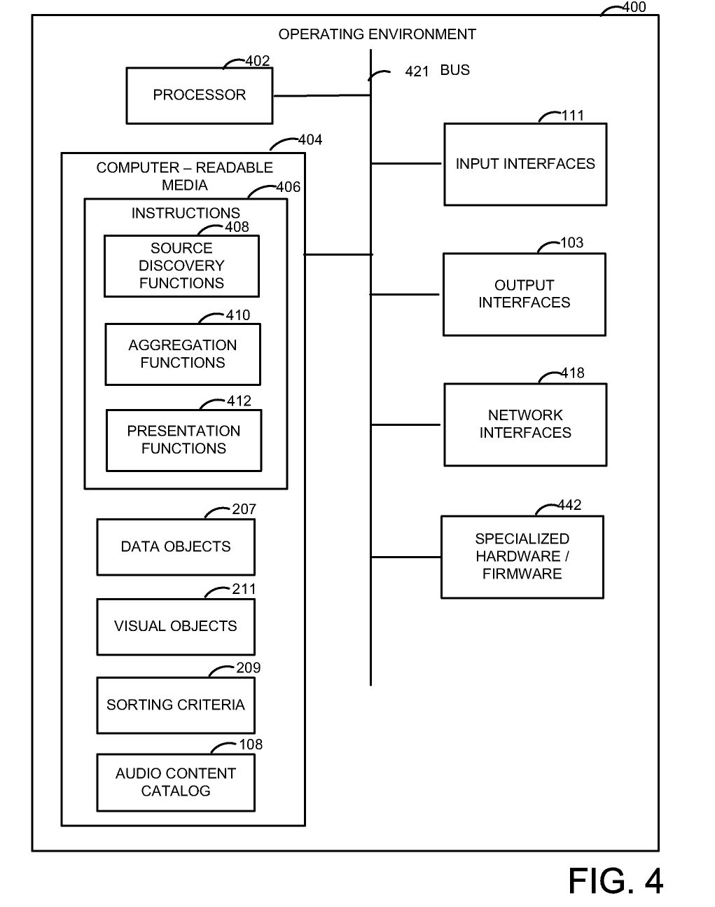

Audio content catalog 108 represents any data construct or physical device defined to store information for accessing audio content items 105 pre-configured for use with video game 101. It will be appreciated that audio content catalog 108 and audio content items 105 stored thereby need not be co-located with video game 101, and may be located in any suitable computer-readable storage medium (computer-readable storage media 404 are shown and discussed further below, in connection with FIG. 4) accessible by video game system 100.

Network servers/services 104 represent any network-based computer-readable storage media from which network-based audio content items 105 may be accessed (via one or more networks 110) by video game system 100. Examples of network servers/services include but are not limited to network-based media download or streaming services or centers. Networks 110 represent any existing or future, public or private, wired or wireless, wide-area or local area, one-way or two-way data transmission infrastructures, technologies or signals. Exemplary networks 110 include: the Internet; managed wide-area networks (for example, cellular networks, satellite networks, fiber-optic networks, co-axial networks, hybrid networks, copper wire networks, and over-the-air broadcasting networks); local area networks; and personal area networks.

Consumer electronic devices 102 represent any known or later developed portable or non-portable consumer devices, including but not limited to: personal computers; telecommunication devices; personal digital assistants; media players or recorders (including such home entertainment devices as set-top boxes, game consoles, televisions, and the like); in-vehicle devices; and individual computer-readable storage media such as hard drives, memory sticks, USB storage devices and the like.

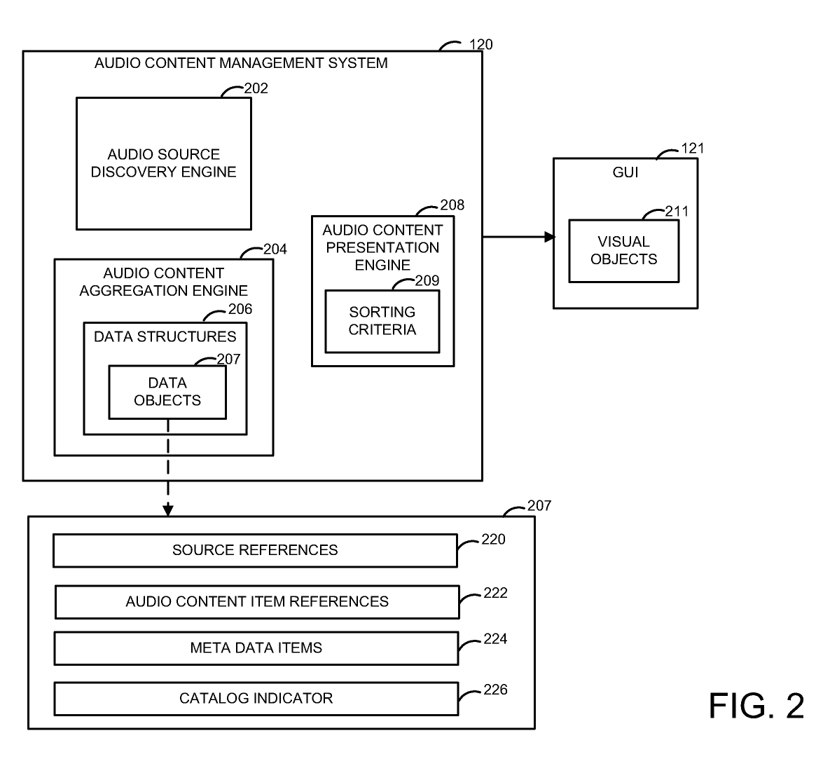

Aspects of an audio content management system (“ACMS”) 120 (discussed in further detail in connection with FIG. 2) are used to manage sets of audio content items 105 stored in different audio content sources that are in communication with video game system 100. Among other things, ACMS 120 is responsible for dynamically rendering GUI 121 in connection with execution of video game 101. GUI 121 visually displays audio content items 105 available from multiple audio content sources in communication with video game system 100 in an integrated manner that enables a user 116 to browse, sort/search, and select particular audio content items 105 for use with video game 101, regardless of the source or original format of the selected audio content items.

With continuing reference to FIG. 1, FIG. 2 is a simplified functional block diagram of ACMS 120. Aspects of ACMS 120 may be implemented within one or more environments within networks 110, such as network-based devices or software applications, one or more client-side operating environments, such as video game consoles, PCs, and the like. In general, design choices and/or operating environments dictate how and whether specific functions of ACMS 120 are implemented. Such functions may be implemented using hardware, software, firmware, or combinations thereof.

As shown, ACMS 120 includes: audio source discovery engine 202; audio content aggregation engine 204 (for populating data structure 206 with data objects 207); and audio content presentation engine 208, which utilize sorting criteria 209.

Audio source discovery engine 202 detects when a particular audio content source is in communication with video game system 100, and defines the way in which ACMS 120 communicates with a particular audio content source to populate data structure 206 (discussed further below). In one possible implementation, multiple protocol adapters (not shown) are defined for a variety of known audio content sources, with each adapter configured to connect to an audio content source using a predetermined protocol, and accommodate the enumeration and/or retrieval of audio content from the audio content source. Such communication may be initiated by ACMS 120 or a particular audio content source. In an alternate embodiment, a specific protocol adapter may be defined that is generally supported by all audio content sources.

Audio content aggregation engine 204 is responsible for enumerating the audio contents of audio content sources detected by audio source discovery engine 202, and for populating data structure 206 (which may be a database, declarative language schema or document, table, array, or another data structure stored in a permanent or temporary computer-readable medium) with data objects 207, which are configured to store data regarding data content items 105 from particular audio content sources. Audio content enumeration generally involves parsing information received from a particular audio content source, and transcribing the information in accordance with the predefined structure of data objects 207. Enumeration of the audio content of detected audio content sources may occur using any known or later developed public or proprietary technique, such as media transfer protocol (“MTP”), and data push or pull techniques may be employed. Data structure 206 may be fully populated with the audio contents of a particular audio content source prior to presentation of GUI 121 to a user, or GUI 121 may present the contents of a particular audio content source “on the fly”—as such contents are discovered and enumerated. Data stored data structure 206/data objects 207 may be selectively available only according to licensing or specifications for a particular video game or system, or may be usable by any video game or system.

Data objects 207 facilitate the cataloging, searching/sorting, and presentation of audio content items 105 from a number of detected audio content sources. As shown, an audio content item reference 222 of a particular data object 207 is used to store data about a particular audio content item 105. Such data may include, but is not limited to: a direct or indirect reference to a storage location of the particular audio content item (such as a URL, a variable, a vector, or a pointer); a reference to a format of the particular audio content item; the particular audio content item itself; and/or a reference to a particular visual object 211 used for representing the particular audio content item via GUI 121.

A source reference 220 of a particular data object 207 is used to store data about a particular audio content source from which a particular audio content source originates. Such data may include but is not limited to direct or indirect references to instructions, protocols, or interfaces usable for establishing communication with the particular audio content source, or a reference to a particular visual object 211 used for representing the particular audio content source via GUI 121. Via audio content item references 222 and/or source references 220, operators in proprietary environments, such as network-based service providers (for example, online music vendors, or cable or satellite providers), may be able to identify available audio content items and still restrict access to the content, or even interact directly with a user, to provide richer user experiences via a particular video game.

Metadata items 224 associated with a particular audio content item may also be stored within one or more data objects 207. Metadata is any descriptive data or identifying information (such as title information, artist information, starting and ending time information, expiration date information, hyperlinks to websites, file size information, format information, photographs, graphics, descriptive text, and the like) in computer-usable form that is associated with an audio content item. Metadata may be provided by different audio content sources, or may be added by ACMS 120 to improve information retrieval. Generally, metadata items 224 would provide enough information to enable GUI 121 to provide a rich discovery and browse scenario of audio content items from a variety of audio content sources without requiring specific knowledge of the user interfaces normally used for managing audio content via the different audio content sources.

A catalog indicator 226 portion is a flag or other construct that indicates when a particular audio content item 105 has been added to the audio content catalog associated with a particular video game 101 (displayable as an icon or other visual object via GUI 121), so that a user knows that the audio content item does not need to be added for use within the video game.

Audio content presentation engine 208 utilizes various sorting criteria 209 to leverage associations between audio content items 105 from various audio content sources, and establishes and provide access to such audio content items via a single GUI 121. Audio content items 105 from multiple sources are generally searchable/sortable using standard search algorithms, based on user-input or automatic queries derived from sorting criteria 209. Subsets of available audio content items that meet one or more sorting criteria 209 may be displayed via the use of various visual objects 211. Because searchable information is organized/correlated in accordance with the format provided by data objects 207, efficient, accurate searching and presentation of audio content items from disparate audio content sources is possible. Virtually unlimited predetermined or dynamically created sorting criteria 209 are possible. Sorting criteria 209 may be received from users, pre-programmed into ACMS 120 in any operating environment, or received from third parties (such as audio content sources). Inferences can also be made by inspecting individual metadata items to create “intelligent” sorting criteria.

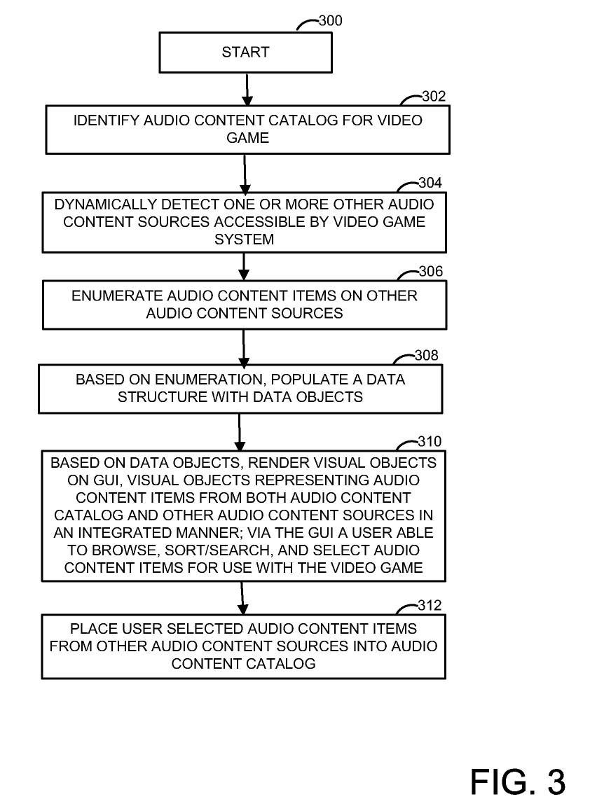

With continuing reference to FIGS. 1 and 2, FIG. 3 is a flowchart illustrating certain aspects of an exemplary method for managing audio content, such as audio content items 105 available from a number of audio content sources, for use with a video game, such as video game 101, via a video game system, such as video game system 100. The method(s) illustrated in FIG. 3 may be implemented using computer-executable instructions executed by one or more general, multi-purpose, or single-purpose processors (exemplary computer-executable instructions 406 and processor 402 are discussed further below, in connection with FIG. 4). Unless specifically stated, the methods described herein are not constrained to a particular order or sequence. In addition, some of the described method or elements thereof can occur or be performed concurrently. It will be understood that all of the steps shown need not occur in performance of the functions described herein.

The method starts at block 300, and continues at block 302, where an audio content catalog for use with the video game is identified, such as audio content catalog 108 for use with video game 101. Next, at block 304, one or more other audio content sources accessible by the video game system are dynamically detected. In the context of ACMS 120, audio source discovery engine 202 may identify specific source adapters/interfaces to communicate with different audio content sources using appropriate communication protocols or techniques.

As indicated at block 306, audio content items on audio content sources identified at block 304 are enumerated, and at block 308, based on the enumeration, a data structure, such as data structure 206 is populated with data objects, such as data objects 207. In the context of ACMS 120, audio content aggregation engine 204 is responsible for enumeration of audio content items and population of data objects 207. Enumeration and data structure population may also involve ACMS 120 adding certain useful computer-usable descriptors or links data structure 206/data objects 207, which can facilitate the identification of relationships between audio content items from different audio content sources.

At block 310, based on the data objects, certain visual objects are rendered on a graphical user interface, such as GUI 121. In the context of ACMS 120, audio content presentation engine 208 displays visual objects 211 associated with audio content item references 222 and/or source references 220, in a manner that enables a user to browse specific visual objects based on a variety of sorting criteria 209, and to select specific visual o objects 211 representing audio media content items for use with video game 101. Sorting/searching generally involves identifying and evaluating relationships between user-input information and metadata items 224, audio content item references 222, and/or source references 220. Sorting criteria 209 may be used in the identification and evaluation of such relationships, and such relationships between may be pre-established or established on the fly. For example, relationships defined by metadata items 224 that meet certain sorting criteria 209 may be pre-established or may be established in response to user input.

In the case where GUI 121 presents the contents of a particular audio content source as such contents are discovered and enumerated, the visual objects of GUI 121 are automatically updated to present to a user the actual available audio content sources and/or audio content items for further interaction. In addition, a counter that tallies the total number of available audio content items may be displayed and dynamically updated. In one possible implementation, an icon is prominently displayed (inline or inline or in another manner) with a visual object representing a particular audio content item, which denotes which source the item originated from. For ease of use, the source indicator icon can be toggled on or off by a user. Any combination of sources toggled on or off is handled. Additionally, if the source is a network-based service, the audio content item may also include other material, such as lyrics and/or a music video, and possibly a price. Icons denoting which of these materials is included with the audio content item may also be displayed inline (or in another manner) with the visual object representing the audio content item.

As indicated at block 312, upon selection of a particular audio content item 105 for use with the video game (from a source other than the audio content catalog), the audio content item is placed into the audio content catalog. It will be appreciated that in the process of enumeration and/or data object population, the audio content item may have already been placed into temporary or permanent memory accessible by video game system 100, or alternatively information within a data object (such as a URL, pointer, vector, or variable) may be used to retrieve the audio content item from the particular audio content source at the time of user selection. Additionally, the process of placing the audio content item into the audio content catalog may involve translating the format of the audio content item to a different format, and/or interacting with network-based services to purchase, license, or otherwise use the audio content item. Any known or developed technique for such format translation may be employed.

In this manner, it is possible to provide a single video game GUI for user selection of audio content items from disparate audio content sources and/or formats. A wide variety of fresh audio content may be discovered and accessed, even when the audio content is not pre-configured for use with the video game. The flexible architecture of ACMS 120 enables efficient yet complex searching and data storage models that accommodate frequently changing audio sources and audio content.

With continued reference to FIGS. 1-3, FIG. 4 is a block diagram of an exemplary configuration of an operating environment 400 (such as a client-side operating environment or a network-side operating environment) in which all or part of ACMS 120, and/or the method(s) shown and discussed in connection with FIG. 3 may be implemented or used. Operating environment 400 is generally indicative of a wide variety of general-purpose or special-purpose computing environments, and is not intended to suggest any limitation as to the scope of use or functionality of the system(s) and methods described herein. For example, operating environment 400 may be a console-type video game system, a PC-based video game system, a video game system implemented within another type of consumer electronic device, or a network-based video game system.

As shown, operating environment 400 includes processor 402, computer-readable media 404, input interfaces 111, output interfaces 103 (input and/or output interfaces implement GUI 121, not shown), network interfaces 418, and specialized hardware/firmware 442. Computer-executable instructions 406 are stored on computer-readable media 404, as are, among other things, data objects 207, visual objects 211, sorting criteria 209, and audio content catalog 108. One or more internal buses 421 may be used to carry data, addresses, control signals and other information within, to, or from operating environment 400 or elements thereof.

Processor 402, which may be a real or a virtual processor, controls functions of operating environment 400 by executing computer-executable instructions 406. Processor 402 may execute instructions 406 at the assembly, compiled, or machine-level to perform a particular process.

Computer-readable media 404 represent any number and combination of local or remote devices, in any form, now known or later developed, capable of recording, storing, or transmitting computer-readable data, such as computer-executable instructions 406, data objects 207, visual objects 211, sorting criteria 209, or audio content catalog 108. In particular, computer-readable media 404 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 404 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 406 represent any signal processing methods or stored instructions. Generally, computer-executable instructions 406 are implemented as software components according to well-known practices for component-based software development, and encoded in computer-readable media (such as computer-readable media 404). Computer programs may be combined or distributed in various ways. Computer-executable instructions 406, however, are not limited to implementation by any specific embodiments of computer programs, and in other instances may be implemented by, or executed in, hardware, software, firmware, or any combination thereof.

As shown, certain computer-executable instructions 406 implement source discovery functions 408, which implement aspects of audio source discovery engine 202; certain computer-executable instructions 406 implement aggregation functions 410, which implement aspects of audio content aggregation engine 204; and certain computer-executable instructions 406 implement presentation functions 412, which implement aspects of audio content presentation engine 208.

Network interface(s) 418 are one or more physical or logical elements that enable communication by operating environment 400 via one or more protocols or techniques usable in connection with networks 110.

Specialized hardware 442 represents any hardware or firmware that implements functions of operating environment 400. Examples of specialized hardware includes encoder/decoders (“CODECs”), decrypters, application-specific integrated circuits, secure clocks, optical disc drives, and the like.

It will be appreciated that particular configurations of operating environment 400 or ACMS 120 may include fewer, more, or different components or functions than those described. In addition, functional components of operating environment 400 or ACMS 120 may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer implemented method for managing audio content for use with a video game playable via a video game system, the method comprising:
identifying an audio content catalog having a first set of audio content items stored thereon, the audio content catalog pre-configured for use with the video game;
detecting an audio content source, other than the audio content catalog, accessible via the video game system, the audio content source having a second set of audio content items stored thereon;
populating a data structure with audio content source data objects based on the second set of audio content items, a particular audio content source data object configured to store data comprising
a reference to the audio content source, and
a reference to a particular audio content item from the second set of audio content items;
via a graphical user interface of the video game, displaying a first set of visual objects representing at least some of the first set of audio content items;
via the graphical user interface, displaying in an integrated fashion with the first set of visual objects a second set of visual objects based on data stored in one or more audio content source data objects; and
receiving a user selection of a particular visual object from either the first set of visual objects or the second set of visual objects,
user selection of a particular visual object from the second set of visual objects resulting in making a particular audio content item from the second set of audio content items available for use with the video game.

2. The computer implemented method according to claim 1, wherein the step of populating the data structure with audio content source data objects comprises:
arranging for enumeration of audio content of the audio source.

3. The computer implemented method according to claim 1, further comprising:
populating the data structure with audio content catalog data objects based on the first set of audio content items, a particular audio content catalog data object configured to store data comprising
a reference to the audio content catalog, and
a reference to a particular audio content item from the first set of audio content items.

4. The computer implemented method according to claim 1, wherein an audio content item of the first set of audio content items comprises a different format than an audio content item of the second set of audio content items.

5. The computer implemented method according to claim 1, wherein the audio content source is selected from the group comprising: a portable media player; a personal computer; a network-based media download service; a streaming media center; an individual computer-readable storage medium; and a digital video recorder.

6. The computer implemented method according to claim 1, wherein the step of detecting an audio content source comprises identifying when communication is established between the video game system and an audio content source via a communication medium.

7. The computer implemented method according to claim 1, wherein the data structure comprises the audio content catalog.

8. The computer implemented method according to claim 1, wherein the video game comprises a interactive music game.

9. The computer implemented method according to claim 1, wherein a reference to a particular audio content item from the second set of audio content items comprises one or more references to a particular audio content item from the second set of audio content items, the one or more references selected from the group comprising: the particular audio content item; a uniform resource locator associated with the particular audio content item; a vector directed to the particular audio content item; a pointer pointing to the particular audio content item; a variable for indirectly accessing the particular audio content item; and a reference to a particular visual object of the second set of visual objects, the particular visual object representing the particular audio content item.

10. The computer implemented method according to claim 1, wherein a reference to the audio content source comprises one or more references to the audio content source, the one or more references selected from the group comprising: a reference to instructions usable for establishing communication with the audio content source; a reference to a protocol usable for communication with the audio content source; a reference to an interface via which communication with the audio content source is established; and a reference to a particular visual object of the second set of visual objects, the particular visual object representing the audio content source.

11. The computer implemented method according to claim 1, wherein a particular audio content source data object is further configured to store
one or more metadata items associated with a particular audio content item of the second set of audio content items, and
a format of a particular audio content item of the second set of audio content items.

12. The computer implemented method according to claim 11, further comprising:
via the graphical user interface, providing a user-selectable control for sorting the second set of visual objects based on the one or more metadata items.

13. The computer implemented method according to claim 1, wherein making a particular audio content item from the second set of audio content items available for use with the video game further comprises:
ascertaining whether the particular audio content item has a format different from a format of the audio content items of the first set of audio content items;
when the formats are different, translating the format of the particular audio content item into the format of the audio content items of the first set of audio content items; and
adding the particular audio content item to the audio content catalog.

14. The computer implemented method according to claim 13, further comprising, when the particular audio content item is added to the audio content catalog:
storing additional data within the particular data object that stores the reference to the particular audio content item, the additional data comprising an indication that the particular audio content item was added to the audio content catalog.

15. The computer implemented method according to claim 14, wherein the second set of visual objects includes, for the particular audio content item of the second set of audio content items, a graphical catalog indicator based on the additional data, the graphical catalog indicator indicating whether the particular audio content item was previously added to the audio content catalog.

16. The computer implemented method according to claim 1, wherein the second set of user-selectable visual objects includes, for a particular audio content item of the second set of audio content items, a graphical source indicator representing the audio content source that can be toggled on or off by a user, and a graphical audio content item indicator representing the particular audio content item.

17. The computer implemented method according to claim 1, wherein the steps of populating the data structure and displaying the second set of visual objects occur dynamically and concurrently, and wherein the second set of visual objects further includes an audio content item counter for displaying a total number of audio content items of the second set of audio content items populating the data structure.

18. The computer implemented method according to claim 17, wherein the audio content item counter displays the total number of audio content items of the second set of audio content items populating the data structure in addition to a total number of audio content items of the first set of audio content items.

19. A computer-readable medium encoded with computer-executable instructions which, when executed by a processor, perform a method for presenting a graphical a user interface to a user of a video game playable via a video game system, the method comprising the steps of:
identifying a plurality of audio content sources having audio content items stored thereon, at least one audio content source having audio content items stored thereon that are not pre-configured for use with the video game;
enumerating at least some audio content items stored on each of the plurality of audio content sources, enumeration of audio content items stored on a particular audio content source producing a set of audio content items;
for a particular set of audio content items, populating a data structure with data objects based on the particular set of audio content items, a particular data object configured to store data comprising
a reference to a particular audio content item from the particular set of audio content items, and
a reference to the particular audio content source from which the particular audio content item was enumerated; and
based on the data objects, rendering, via a single graphical presentation tool, a plurality of visual objects, the plurality of visual objects including user-selectable representations of at least some audio content items stored on each of the plurality of audio content sources,
user selection from among the plurality of visual objects resulting in audio content items from each of the plurality of audio content sources being made available for use with the video game.

20. A video game system, comprising:
a computer-readable storage medium; and
a processor responsive to the computer-readable storage medium and to a computer program, the computer program, when loaded into the processor, operable to perform a method for presenting a graphical a user interface for a video game playable via the video game system, the method comprising:
identifying a plurality of audio content sources having audio content items stored thereon, at least one audio content source having audio content items stored thereon that are not pre-configured for use with the video game;
detecting a particular audio content source from the plurality of audio content sources, the particular audio content source having audio content items stored thereon that are not pre-configured for use with the video game;
populating a data structure with data objects based on the audio content items stored on the particular audio content source, a particular data object configured to store data comprising
a reference to the particular audio content source, and
a reference to a particular audio content item stored on the particular audio content source; and
displaying an integrated set of visual objects for user selection, the integrated set of visual objects comprising at least a first visual object representing a particular audio content item configured for use with the video game and a second visual object representing a particular audio content item from the particular audio content source, the second visual object rendered based on the data structure,
user selection of a particular visual object resulting in the particular audio content item represented by the particular visual object being used with the video game.
